(19) United States
(12) Patent Application Publication
(10) Pub. No.: US 2011/0040617 A1
(43) Pub. Date: Feb. 17, 2011

(54) MANAGEMENT OF PUBLISHER YIELD

(75) Inventors: Rajas Moonka, San Ramon, CA (US); Sean Harvey, Astoria, NY (US); Jason C. Miller, San Francisco, CA (US); Joerg Heilig, Los Altos, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/539,304

(22) Filed: Aug. 11, 2009

(51) Int. Cl. G06Q 30/00; G06Q 10/00

(52) U.S. Cl. 705/14.46; 705/14.73; 705/14.69

(57) ABSTRACT

Publisher yield can be managed by establishing a revenue model that represents a relationship between ad revenue for a publisher of a web site and a plurality of parameters. The parameters can include, e.g., a minimum price for an advertiser to place an ad on a web page of the web site through an ad network, a number of advertiser ads presented on the web page, and a number of house ads presented on the web page. Values of the parameters are adjusted based on the revenue model to increase the ad revenue to the publisher. This may include adjusting the minimum price for an advertiser to place an ad on the web page through the ad network, the number of advertiser ads presented on the web page, and/or the number of house ads presented on the web page.

### TECHNICAL FIELD

This document generally relates to information management.

### BACKGROUND

Publishers of web sites may generate revenue by presenting (e.g., displaying) advertisements (“ads”) along with other web content (e.g., search results, news, articles, or other information). The selection of ads for presentation and the ordering of the ads may be achieved by various techniques. In one exemplary technique, a determination is made to identify advertisements that are a match or near match for content of web pages or predetermined criteria for the placement of ads. The match may be made, for example, between one or more words in the content or URLs of the web pages where the ads are to be placed, and keywords associated with a particular advertisement or group of advertisements.

The publishers may increase ad revenue by, e.g., increasing the number of ads presented on the web sites. By showing more ads, more users may be interested in the products or services being advertised and click on the ads, generating more revenue for the publishers.

### SUMMARY

Publishers can increase ad revenue by using machine learning or multivariate experimentation to optimize various parameters in an ad delivery system in which advertisers pay for placement of ads on web sites of the publishers. The parameters can include, e.g., the minimum price for an advertiser to place an ad on a page of a web site of a publisher through an ad network (such as min-CPM: minimum cost per thousand impressions), and the number of advertiser ads or house ads presented at various pages of the web site. For example, rather than adding as many advertisements on the web page as possible, the min-CPM can be adjusted to allow an optimum number of ads to be presented on the web page to maximize the ad revenue for the publisher. In some cases, the system may reduce the number of ads placed on the web page and instead place house ads in the left-over ad spaces.

In general, in one aspect, a method for managing publisher yield includes establishing a revenue model representing a relationship between ad revenue for a publisher of a web site and a plurality of parameters, the parameters including at least one of (a) a minimum price for an advertiser to place an ad on a web page of the web site through an ad network, (b) a number of advertiser ads presented on the web page, or (c) a number of house ads presented on the web page, the advertiser ads being provided by advertisers and the house ads promoting products, services, or web page content of the publisher. The method includes at one or more computers, adjusting values of the parameters based on the revenue model to increase the ad revenue to the publisher, the parameters including at least one of the minimum price for an advertiser to place an ad on the web page through the ad network, the number of advertiser ads presented on the web page, or the number of house ads presented on the web page. The method includes outputting at least one of (d) an instruction to an ad network to cause the ad network to adjust the minimum price for an advertiser to place an ad on the web page through the ad network, (e) an instruction to cause a web server to adjust the number of advertiser ads on the web page, or (f) an instruction to cause the web server to adjust the number of house ads on the web page.

Implementation of the method may include one of more of the following features. The revenue model can apply weights to the parameters. The method can include adjusting the weights applied to the parameters to increase the accuracy of the revenue model in representing the relationship between the ad revenue for the publisher and the plurality of parameters.

The method can include determining values for the parameters that maximize the ad revenue to the publisher.

The minimum price for an advertiser to place an ad on the web page through an ad network can include a minimum cost to an advertiser per predefined number of impressions.

The minimum price can include at least one of a minimum cost per thousand impressions (min-CPM).

The minimum price for an advertiser to place an ad on the web page through an ad network can include the minimum price for an advertiser to place an ad at a particular ad space of the web page through the ad network.

The web site includes a plurality of web pages, and the parameters can include the number of advertiser ads presented at each of the web pages, or the number of house ads presented at each of the web pages.

Adjusting the values of the parameters at one or more computers can include at a web server hosting the web site, adjusting at least one of a number of advertiser ads or a number of house ads presented on the web page.

Adjusting the values of the parameters at one or more computers can include at a computer of the ad network, adjusting the minimum price.

Adjusting the values of the parameters at one or more computers can include at a computer, sending instructions to a web server hosting the web page to cause the web server to adjust at least one of a number of advertiser ads or a number of house ads presented on the web page.

Adjusting the values of the parameters at one or more computers can include at a computer, sending instructions to the ad network to cause the ad network to adjust the minimum price.

In general, in another aspect, a method for managing publisher yield includes setting various minimum prices for placement of ads on a web page of a web site of a publisher through an ad network for various portions of web traffic, identifying ad revenue to the publisher generated by the ads provided by the ad network for each minimum price during a respective portion of web traffic, determining at a computer a particular minimum price that results in maximum ad revenue for the publisher, setting the minimum price for the placement of ads on the web site through the ad network at the particular minimum price, and providing the web page including ads or links to the ads selected according to the particular minimum price to end users.

Implementations of the method may include one or more of the following features. The ad revenue can include ad revenue per predefined number of clicks.

The computer can iteratively adjust the minimum price for placement of ads on the web site through the ad network and determine the ad revenue to the publisher generated by the ads after adjustment of the minimum price, the iterative adjustment for increasing the ad revenue over time.

The various portions of web traffic can include page views associated with the web page during different periods of time, or different portions of all of the page views associated with the web page during a same period of time.

In general, in another aspect, a method for managing publisher yield includes presenting ads on a web page of a web site of a publisher, identifying ad revenue to the publisher generated by the ads, determining at a computer the number of ads presented at the web page that results in maximum ad revenue to the publisher, and presenting the number of ads at the web page.

Implementations of the method may include one or more of the following features. The ad revenue can include ad revenue per predefined number of clicks.

The computer can iteratively adjust the number of ads presented at the web page and determine the ad revenue to the publisher generated by the ads, the iterative adjustment for increasing the ad revenue over time.

The web site includes a plurality of web pages, and the method can include adjusting the number of ads presented at each of the web pages.

Determining the number of ads presented at the web page that results in maximum ad revenue to the publisher can include determining at least one of the number of advertiser ads or the number of house ads presented at the web page.

The method can include determining that placing a house ad at an ad space on the web page increases the ad revenue more than placing an advertiser ad at the ad space, and placing the house ad at the ad space.

In general, in another aspect, a system includes a machine learning module to provide a revenue model representing a relationship between ad revenue for a publisher of a web site and a plurality of parameters. The parameters include at least one of (a) a minimum price for an advertiser to place an ad on a web page of the web site through an ad network, (b) a number of advertiser ads presented on the web page, or (c) a number of house ads presented on the web page, the advertiser ads being provided by advertisers and the house ads promoting products, services, or web page content of the publisher. A yield manager uses the revenue model to adjust values of the parameters to increase the ad revenue to the publisher, including adjusting at least one of the minimum price for an advertiser to place an ad on the web page through the ad network, the number of advertiser ads presented on the web page, or the number of house ads presented on the web page.

Implementations of the system can include one or more of the following features. The revenue model can include weights that are applied to the parameters, and the machine learning module can adjust the weights applied to the parameters to increase accuracy of the revenue model in representing the relationship between the ad revenue for the publisher and the plurality of parameters.

The yield manager can adjust the values of the parameters to maximize the ad revenue to the publisher.

The minimum price can include a minimum cost to an advertiser per predefined number of impressions.

The minimum price can include a minimum cost per thousand impressions (min-CPM).

The web site includes a plurality of web pages, and the parameters can include the number of advertiser ads presented at each of the web pages.

The web site includes a plurality of web pages, and the parameters can include the number of house ads presented at each of the web pages.

These and other aspects and features, and combinations of them, may be expressed as methods, apparatus, systems, means for performing functions, program products, and in other ways.

Advantages of the aspects and features include none, one, or more of the following. A publisher can optimize (e.g., maximize) its ad revenue and provide higher quality ads to end users. Publishers can provide better user experiences and increase traffic on their websites.

The details of one or more implementations are set forth in the accompanying drawings and the description below. Other features and advantages will be apparent from the description and drawings, and from the claims.

### DESCRIPTION OF DRAWINGS

FIG. 1 is a block diagram of an example on-line environment in which a publisher ad server having a publisher yield manager operates.

FIG. 2 is a diagram of example publisher web sites having advertiser ads and house ads.

FIG. 3 is a block diagram of an example on-line environment in which a publisher yield manager operates.

FIG. 4 is a flow diagram of an example process for managing publisher yield.

FIG. 5 shows an example system that enables a publisher yield manager to manage multiple ads on one or more web pages of a web site by using universal tags.

FIG. 6 shows an example code segment for implementing a universal tag.

FIG. 7 shows an example sequence for configuring and presenting advertising information.

FIG. 8 is a schematic representation of a general computing system.

Like reference symbols in the various drawings indicate like elements.

### DETAILED DESCRIPTION

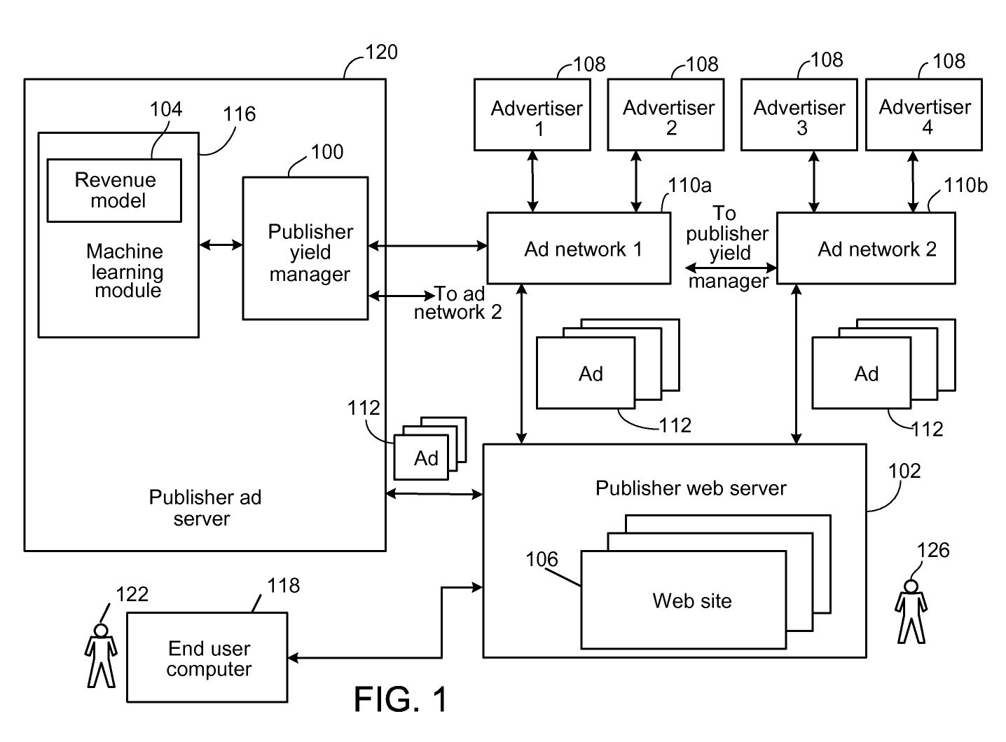

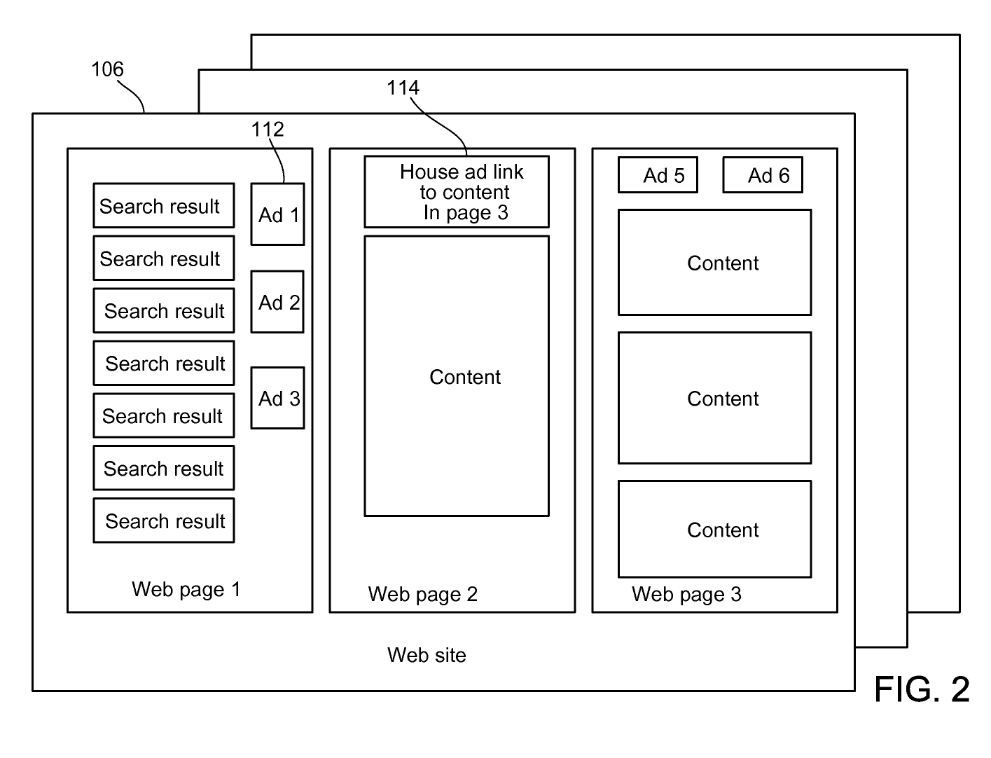

Referring to FIGS. 1 and 2, in some implementations, a publisher ad server 120 manages ad space on one or more web sites 106 that are hosted on a publisher web server 102 operated by a publisher 126. The web sites 106 can be accessed by end users 122 through end user computers 118. The publisher ad server 120 includes a publisher yield manager 100 that manages the ad revenue (or yield, profits) for the publisher 126 by managing the ad inventory of the publisher 126. For example, the publisher yield manager 100 may adjust the min-CPM for various types of ads presented on various pages of the websites 106 to evaluate the overall market demand and set prices most appropriately for the publisher 126 on a real-time basis. The publisher yield manager 100 may adjust various parameters related to the ads, such as the number of advertiser ads (e.g., 112) or house ads (e.g., 114 in FIG. 2) shown on various pages of the web sites 106, to evaluate the optimal number of ads for each page of the publisher's web sites 106, and set the number of ad units on the pages of the web sites 106 accordingly.

An “advertiser ad” 112 herein refers to an ad that is provided by an advertiser 108, and a “house ad” 114 refers to an ad that is provided by the publisher 126 to promote the products, services, or web page content of the publisher 126. A house ad does not necessarily look like an ad per se, and can simply be a message or link directing the user to another web page that potentially may result in higher ad revenue. For example, a house ad on a religion page may include a list of links to the most popular news or sports articles on the web site.

For example, the publisher ad server 120 may manage direct-sale ad inventory and indirect-sale ad inventory. For the direct-sale ad inventory, the publisher 126 sells ad spaces to the advertisers 108 directly. For indirect-sale ad inventory, the publisher 126 sells ad spaces to ad networks 110s, which sell the ad spaces to the advertisers 108. The ad networks 110 often bundle ad spaces from several publishers and sell the ad spaces in the aggregate to advertisers 108. For example, an ad network 110 may sell an ad space for on-line newspaper web sites. An advertiser 108, when purchasing such an ad space, knows that its ad will be delivered to an on-line newspaper web site, but does not know in advance the specific on-line newspaper web site that the ad will be delivered to.

When the publisher ad server 120 determines which ad to place on an ad space on a web page, the publisher ad server 120 may search in its direct-sale ad inventory to determine if there is a suitable ad. If the ad server 120 does not find any suitable ad, the ad server 120 may select one of the ad networks 110, provide a set of criteria to the selected ad network 110, and let the ad network 110 select an ad based on the set of criteria. The term “min-CPM” depending on context can refer to the min-CPM for direct-sale ads or the min-CPM for ads provided by the ad networks 110.

The publisher yield manager 100 evaluates how various parameters affect publisher ad revenue, and optimizes the parameters to optimize (e.g., maximize) the publisher ad revenue. In some implementations, the publisher yield manager 100 interacts with a machine learning module 116 that learns a revenue model 104 representing a relationship between the publisher ad revenue and various parameters. The publisher yield manager 100 and the machine learning module 116 iteratively adjust the parameters, obtain feedback information, update the revenue model 104 based on the feedback information, and adjust the parameters further based on the updated revenue model 104 to optimize the publisher yield.

In some implementations, the revenue model 104 is a statistical regression model. The machine learning module 116 adjusts various parameters of the revenue model 104 and weights applied to the parameters over time to determine the values that result in the highest probability of generating the maximum revenue for the publisher 126.

For example, too many ads on a web page may lead to a decline in user traffic, while too few ads may lead to under monetization. Some web pages may generate more revenue than other web pages, so it may be preferable for a publisher 126 to send traffic from a first page to a second page on the website through promotion rather than running an ad on the first page. For example, automobile pages of an online edition of a newspaper's website may generate more revenue from ads than religion pages of the same website. The machine learning module 116 optimizes the number of advertiser ads and the number of house ads for each web page of the publisher's web sites to maximize the publisher's ad revenue.

The publisher yield manager 100 estimates the potential ad revenue for each page of the web site, and determines whether in some instances it is better to show house ads rather than advertiser ads, and which pages the house ads should redirect the users to. For example, suppose a news web site has a main page, a politics page, a sports page, an automobiles page, and a technology page. The publisher yield manager 100 estimates the potential ad revenue generated from each of the main page, the politics page, the sports page, the automobiles page, and the technology page. Suppose the publisher initially allocated four ad units for the politics page. During part of the optimization process, the publisher yield manager 100 may determine whether the fourth ad unit should be an advertiser ad or a house ad linking to another page.

For example, suppose the revenue from presenting an advertiser ad is 20 cents. Suppose the yield manager 100 estimates the probability that a user will click on a house ad linking to the automobiles page is about 1%, and the potential revenue from the automobiles page is about $10, then the potential revenue from displaying a house ad linking to the automobiles page is about 10 cents. In this case, it is better to present an advertiser ad at the fourth ad unit than to present a house ad linking to the automobiles page. Suppose the yield manager 100 estimates the probability that a user will click on a house ad linking to the technology page is about 3%, and the potential revenue from the technology page is about $8, then the potential revenue from displaying a house ad linking to the technology page is about 24 cents. In this case, it is better to present a house ad linking to the technology page at the fourth ad unit rather than to present an advertiser ad. The publisher yield manager 100 may cause the publisher ad server 120 to automatically generate a house ad with a link to the technology page.

When estimating the potential revenue from a house ad, the publisher yield manager 100 takes into account the likelihood that the user will view additional pages in the publisher site after being redirected by the house ad. For example, in the example above, if 5% of the users that viewed the technology page also goes on to view the automobiles page, then the additional potential revenue from the automobiles page is taken into account when calculating the estimated revenue for the house ad that links from the politics page to the technology page.

In some implementations, the publisher yield manager 100 iteratively estimates the potential revenue from each web page, and optimizes the configuration of the advertiser and house ads based on the estimation. When the configuration of advertiser and house ads for a web page changes, the potential revenue for that page may also change. Thus, in each later iteration, the publisher yield manager 100 estimates the potential revenue from each web page that was optimized in an earlier iteration, and optimizes the configuration of the advertiser ads and house ads based on the current estimated revenue for each page.

Suppose the publisher initially allocated three ad units to the politics page. The publisher yield manager 100 determines whether to keep only one ad unit, only two ad units, or all three ad units on the politics page. For each ad unit, the publisher yield manager 100 determines whether to place an advertiser ad or a house ad. The publisher yield manager 100 estimates the potential revenue for the various combinations of advertiser and house ads, and selects the combination that is likely to generate the highest revenue for the publisher.

In some implementations, the publisher yield manager 100 not only optimizes the number of advertiser and house ads on the web pages, but also determines which of the several ad units on each web page should be kept or removed. For example, suppose the publisher initially allocated four ad units (a top banner ad unit, a left skyscraper ad unit, a right skyscraper ad unit, and a bottom banner ad unit) to a web page. The publisher yield manager 100 may, through experimentation, determine that it is better to keep the top banner ad, the left skyscraper ad, and the bottom banner ad, and remove the right skyscraper ad.

For example, the machine learning module 116 may divide web traffic (e.g., page views associated with a web page) during a period of time into several portions and assign different values to a parameter (e.g., the parameter can be the min-CPM for a particular type of ads provided by a particular ad network 110 for a particular ad space on a particular web page on a particular web site 106) for different portions of the web traffic. The machine learning module 116 compares the revenue derived from the different portions of the web traffic, and updates the revenue model 104 based on the comparison. The publisher yield manager 100 sets the parameter according to the comparison in order to maximize the publisher's revenue. For example, the machine learning module 116 may determine that a particular min-CPM will likely result in maximum ad revenue for the publisher. The publisher yield manager 100 sets the min-CPM at the particular min-CPM. For example, the different portions of the web traffic can refer to page views associated with the web page during different periods of time. For example, the different portions of the web traffic can refer to different portions of all of the page views associated with the web page during the same period of time.

The publisher web server 102 may receive ads from one or more ad networks (e.g., 110a and 110b, collectively referenced as 110) and ad exchanges (not shown in the figure). Each ad network 110 and ad exchange may include an ad server that provides ads to the publisher web server 102 in response to ad requests. For example, the ad server may select ads having keywords that match keywords in user queries or web page content, and provide the ads to the publisher web server 102. The ads can be sorted according to types or categories, such as ads for consumer products, ads for financial services, ads for restaurants, and ads for real estate. Ads can also be sorted according to, e.g., whether they are text ads, Flash ads, or video ads. Different types of ads may have different pricing (such as different min-CPM), depending on how they impact user behavior in the aggregate. For example, the publisher yield manager 100 may communicate with the ad network 110 to adjust the min-CPM for various types of ads 112, determine how the min-CPM's affect the ad revenue for the publisher 126, and determine the optimum min-CPM's for the various types of ads.

If initially the min-CPM is set to be low, increasing the min-CPM may reduce ad inventory so that advertisers 108 are willing to pay more fees for each ad. This is because when the ad inventory is low, the likelihood of an ad being clicked by an end user 122 increases. Also, brand advertisers may be willing to pay more to attract greater attention from users, and may prefer to appear on pages where there are fewer ads competing for the user's attention. The quality of the ads may also become higher when the min-CPM increases. However, if the min-CPM is set too high, even though the fee for each ad may be higher, the advertisers 108 may only be willing to pay for a small number of ads such that the overall publisher ad revenue is reduced. By using the revenue model 104, the publisher yield manager 100 can determine the best min-CPM's for various types of ads that result in the maximum ad revenue for the publisher 126. The market conditions (e.g., advertisers' budgets and preferences, types of ads, and ad qualities) may change over time. The machine learning module 116 continuously updates the revenue model 104, and the publisher yield manager 100 continuously adjusts the min-CPM's based on the updated revenue model 104, which reflects the current market conditions.

In some implementations, the publisher yield manager 100 may communicate with the publisher web server 102 to adjust the number of advertiser ads 112 and house ads 114 shown on various pages of the web sites 106, determine how the number of advertiser ads 112 and house ads 114 affect the revenue, and determine the optimum number of advertiser ads 112 and house ads 114 for each page of the web sites 106. The publisher yield manager 100 may determine that, for some web pages, it is better to have no ads.

Increasing the number of ads on a web site may increase the likelihood that some of the ads may be clicked, but placing too many ads on a web site may distract visitors to the web site and reduce the number of ad clicks. Also, when there are too many ads on a web site, the click-through-rate for each ad may be reduced, causing the advertisers 108 to lower the amounts that they are willing to pay for the ads. Thus, optimizing the number of ads shown on the web sites 106 can be useful in optimizing the ad revenue to the publisher 126. When designing the web sites 106, the publisher 126 may allocate a certain number of ad spaces in various web pages of the web sites 106. The publisher yield manager 100 may determine that there are too many ads for certain web pages, and communicate with the publisher web server 102 to adjust the web pages of the web sites 106 to either reduce the number of ad spaces or place house ads 114 at some of the ad spaces.

A house ad 114 may be placed in one web page of the web sites 106 and provide one or more links to one or more other web pages of the web sites 106. For example, the publisher yield manager 100 may determine that showing the ads provided by the ad network 110 on a religion web page may have lower monetary returns, as compared to showing the ads on a sports web page, even though the religion web page may have high quality content and attract a large number of visitors. Visitors viewing the religion web page may be less likely to make on-line purchases, as compared to visitors viewing the sports web page. The publisher yield manager 100 may adjust one or more pages of the web site 106 to place a house ad 114 at the religion web page that provides one or more links to the sports web page of the web sites 106.

The publisher web server 102 may receive ads from more than one ad network (such as 110a and 110b) or ad exchange. The compositions of ads from different ad networks 110 and ad exchanges may be different, so the publisher yield manager 100 may set the parameters differently for different ad networks 110 and ad exchanges. For example, suppose each of the ad networks 110a and 110b provides restaurant ads and consumer product ads. The machine learning module 116 may treat the restaurant ads and consumer product ads from the ad networks 110a and 110b as four different types of ads, and the publisher yield manager 100 may communicate with the ad networks 110a and 110b to adjust the four types of ads to determine how they affect the publisher yield. The publisher yield manager 100 may determine different min-CPM's for restaurant ads from the ad networks 110a and 100b, and different min-CPM's for consumer product ads from the ad networks 110a and 110b.

The publisher yield manager 100 can manage both direct-sale ad inventory and indirect-sale ad inventory. For example, the publisher ad server 120 may serve ads from the direct-sale ad inventory first, and if no suitable ad in the direct-sale ad inventory can be found, serve ads provided by the ad networks 110. Based on the revenue model 116, the publisher yield manager 100 may determine that, in some cases, it is better to serve an ad from one of the ad networks 110 even though an ad from the direct-sale inventory is available. For example, suppose the min-CPM for the direct-sale ad inventory for a particular ad space is $5, and the revenue model 104 indicates that the optimal min-CPM for this ad space is $10. The publisher yield manager 100 may cause the publisher ad server 120 to withhold serving an ad from the direct-sale ad inventory, and instead request the ad network 110 to provide an ad with the min-CPM set to $10.

The revenue model 104 may include weights that are applied to the various parameters. For example, suppose web pages having two ad units may receive 5% of the aggregate RPM for the page, web pages having three ad units may receive 85% of the aggregate RPM for the page, and web pages having four ad units may receive 10% of the aggregate RPM for the page. Let parameters X1, X2, and X3 represent the number of web pages having two ad units, three ad units, and four ad units, respectively. The contributions of the parameters X1, X2, and X3 to the publisher ad revenue may be represented as 0.05*X1+0.85*X2+0.1*X3. Because more ad revenue comes from web pages having three ad units, the publisher yield manager 100 may change the number of ad units on the publisher's web pages to three. For web pages having four or more ad units, the publisher yield manager 100 may reduce the number of ad units on those web pages, or replace some of the advertiser ads with house ads to promote other content of the publisher. The publisher ad revenue may be a linear or non-linear function of the parameters of the revenue model 104.

The publisher yield manager 100 can change the number of ad units on the publisher web pages dynamically and/or fill in some ad units with other publisher content. This may reduce an effect known as banner blindness, which may occur where users learn to ignore ads because the ads typically appear in common places on a website. Periodically substituting or rearranging content reduces the likelihood that users will ignore these areas on the website.

The machine learning module 116 may continuously evaluate the parameters and adjust the weights. The machine learning module 116 may also add parameters to or remove parameters from the revenue model 104. For example, a human designer of the revenue model 104 may list a thousand parameters that may potentially affect ad revenue, and initially select one hundred parameters that may be most relevant to the publisher ad revenue. The parameters of the revenue model 104 may include, e.g., min-CPM, the number of advertiser ads, and the number of house ads. The machine learning module 116 may evaluate the current model, construct a new version of the revenue model 104 that includes additional parameters or has some parameters removed, and compare the new version of the revenue model to the old version. If the new version is better, e.g., the new version can be used to more accurately estimate the publisher ad revenue, the old version is replaced by the new version. The machine learning module 116 continues to evaluate other parameters (of the one thousand parameters) and adjust the revenue model 104 over time. The other parameters that can be factored into the revenue model 104 may include, e.g., time of day of web site access, user browser type, geographical region of user, IP address of user, user's browsing pattern on web site, user's language preference, speed of the user's network connection, registration information from user, and whether users on certain pages respond more or less to particular ad types. Information about the users may be obtained from user registration entries or cookie files. Preferably, to ensure privacy of the users, the machine learning module 116 does not store personally identifiable information.

In the example of FIG. 1, the publisher yield manager 100 is provided as part of the publisher ad server 120 and has access to publisher private data. The publisher yield manager 100 can make yield decisions based on all the information available to the publisher 126. In some implementations, the publisher yield manager 100 can be provided as part of the ad networks 110. In this case, the publisher yield manager 100 makes yield decisions based on the limited information that is available to the ad networks 110.

In some examples, each web page may include one or more HTML tags that specify information about one or more ad units on the page. The HTML tags may include links to ad servers for requesting ads to be presented in relevant spaces on the page. If there are multiple ad units in the page, there may be corresponding multiple HTML tags. When a user's web browser renders the web page, the browser may send multiple ad requests to the ad server, each ad request associated with one of the ad units.

In order for the publisher yield manager 100 to adjust the number of ads presented on the page, the yield manager 100 can instruct the publisher web server 102 to modify the web page (e.g., remove the HTML tag associated with an ad unit to remove the ad unit), or control the delivery of ads in response to the ad requests. For example, if a web page originally has four HTML tags associated with four ad units, and the yield manager 100 determines that it is better to have only three ad units on the page, the yield manager 100 may instruct the publisher ad server 120 to return a blank ad for an ad request associated with the fourth ad unit.

In some implementations, the publisher web pages each includes a universal tag that is configured for use in requesting multiple ads for the web page. Thus, when the user's web browser renders a web page that has four ad units, instead of sending four ad requests, the web browser sends one universal ad request for all four ad units, and the publisher ad server 120 responds by sending one response with four ads. For example, if the publisher yield manager 100 determines that it is better to server only three ads on the page, the yield manager 100 instructs the publisher ad server 120 to respond with three advertiser ads and one blank ad upon receiving the universal ad request from the user's web browser. By using universal tags, it is easier for the publisher ad sever 120 to control the presentation of ads on the web pages, including the number of ads and the type of ads (e.g., advertiser ad or house ad). Implementations of the universal tag are described in more detail below.

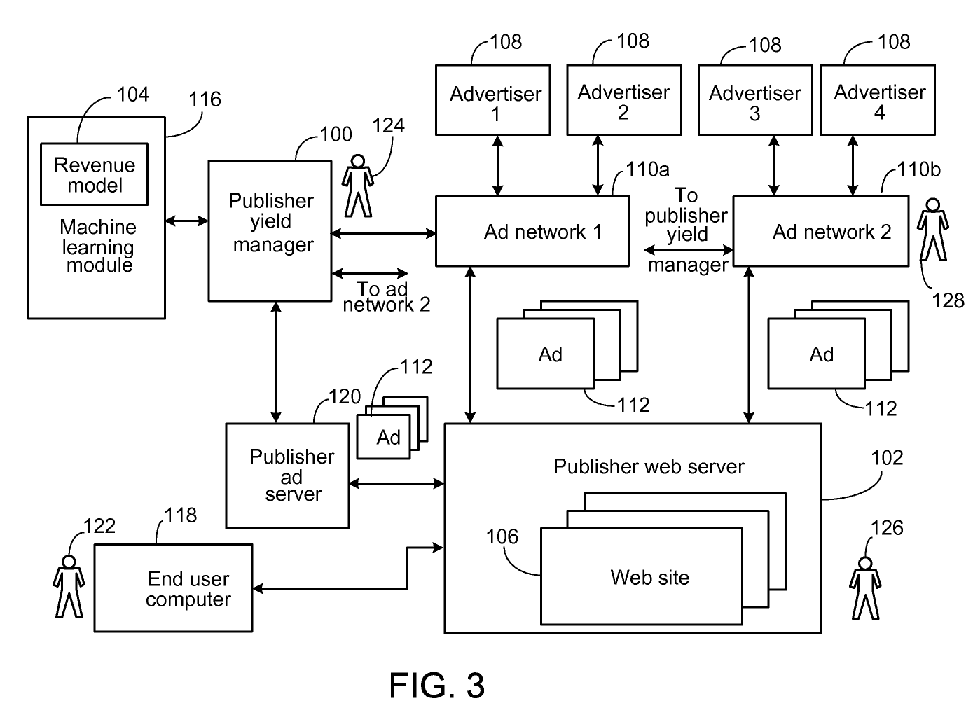

Referring to FIG. 3, in some implementations, the publisher yield manager 100 can be operated by an operator 124 who is independent of the publisher 126 and the operators 128 of the ad networks 110. The operator 124 may license the publisher yield manager 100 to the publisher 126 or the ad network operator 128 for a fee. The fee can be a flat rate or be based on a percentage of the increase in revenue facilitated by the publisher yield manager 100. For example, an experimental framework can be set up in which the publisher traffic is divided into a first portion that is managed by the publisher yield manager 100 and a second portion that is not managed by the publisher yield manager 100. Comparing the revenue generated by the first and second portions allows one to determine the effective percentage increase in revenue per thousand impressions (RPM) derived from the use of the publisher yield manager 100. The revenue of the operator 124 can be based on the percentage applied to all publisher impressions.

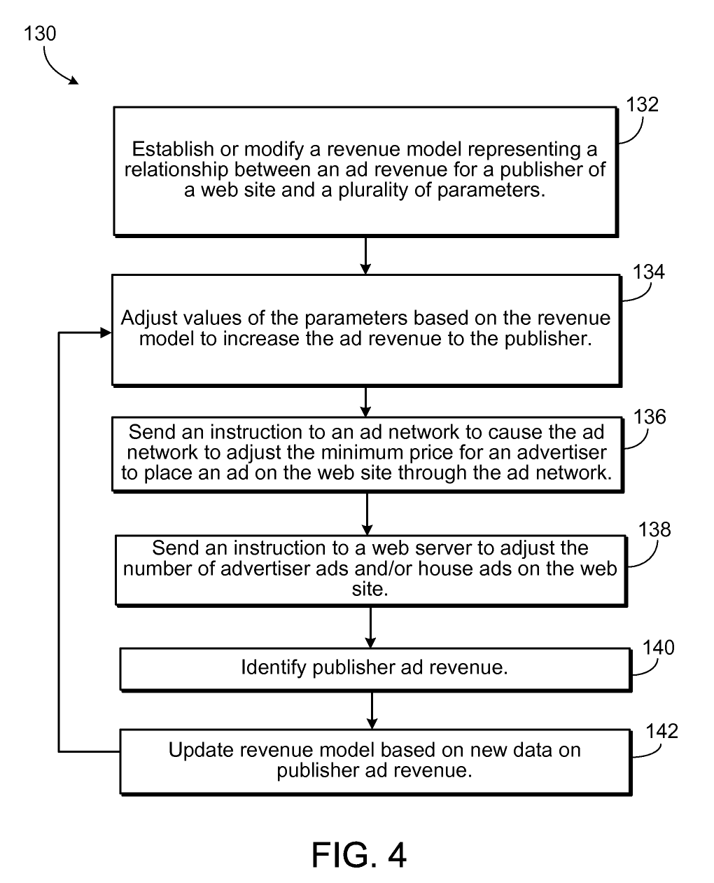

FIG. 4 is a flow diagram of an example process 130 for managing publisher yield. A revenue model is established, in which the revenue model represents a relationship between ad revenue for a publisher of a web site and a plurality of parameters (132).

For example, the revenue model can be the revenue model 104 shown in FIG. 1, and the parameters can include the minimum price (or reserve price) for an advertiser to place an ad on the web site through an ad network, the number of advertiser ads presented on the web site, or the number of house ads presented on the web site. The revenue model can be established by the machine learning module 116. The minimum price can be specified as min-CPM.

Values of the parameters are adjusted based on the revenue model to increase the ad revenue to the publisher (134). This may include adjusting the minimum price for an advertiser to place an ad on the web site through the ad network, the number of advertiser ads presented on the web site, or the number of house ads presented on the web site. For example, the values of the parameters can be determined by the publisher yield manager 100 and adjusted by the machine learning module 116.

An instruction can be sent to an ad network to cause the ad network to adjust the minimum price for an advertiser to place an ad on the web site through the ad network (136). For example, the publisher yield manager 100 can send the instruction, and the ad network can be the ad network 110.

An instruction can be sent to a web server to cause the web server to adjust the number of advertiser ads and/or house ads on the web site (138). For example, the publisher yield manager 100 can send the instruction, and the web server can be the publisher web server 102.

After adjustment of the minimum price for placement of an ad, or adjustment of the number of advertiser ads or house ads, the publisher ad revenue is identified (140). For example, the publisher yield manager may query an administrative module of the publisher to identify the publisher ad revenue, such as ad revenue per thousand impressions.

Based on the new data on publisher ad revenue, the revenue model is updated (142). For example, the machine learning module 116 can update the revenue model 104 based on the new publisher ad revenue data.

After the revenue model is updated, the process 130 repeats steps 134 to 142 to optimize the parameter values to optimize (e.g., maximize) the publisher ad revenue.

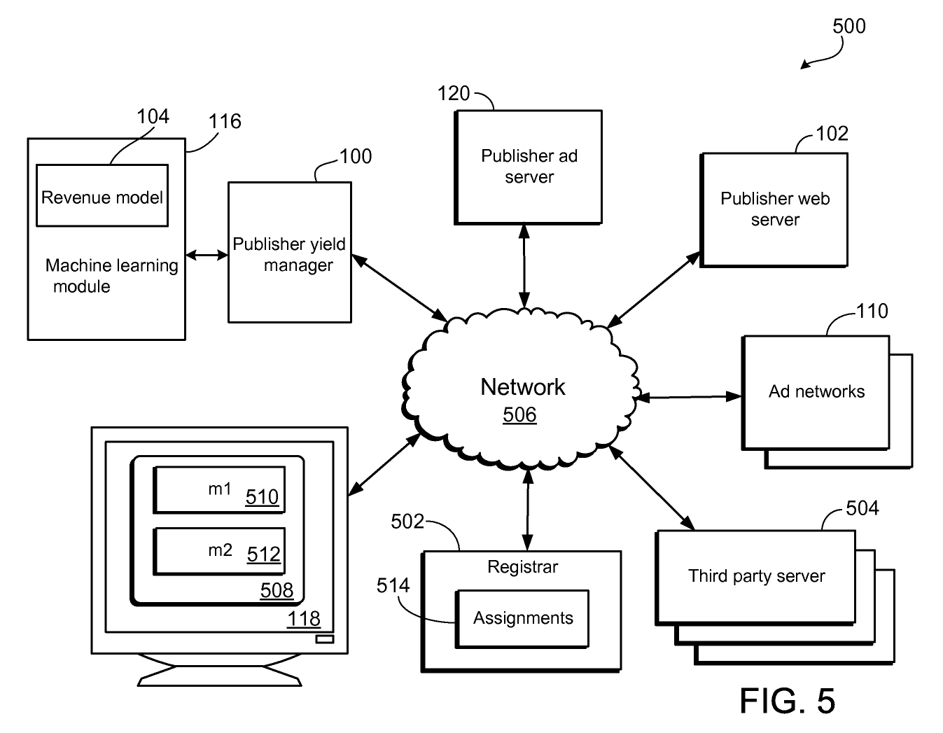

Referring to FIG. 5, an example system 500 enables a publisher yield manager 100, in cooperation with a machine learning module 116, to manage multiple ads on one or more web pages of a web site by using universal tags. The system 500 can be used for delivering content such as publisher's pages. The system 500 includes at least one end user computer 118 for viewing content, a publisher ad server 120 that manages ad space on one or more web sites that are hosted on a publisher web server 102, a registrar system 502 for managing the mapping of service information, one or more third party servers 504 for providing services such as sourcing content, and ad networks 110 that may bundle ad spaces from several publishers and sell the ad spaces in the aggregate to advertisers. The components of the system 500 can communicate through a computer network 506, which can be the Internet, an internal LAN, or any other computer network.

For example, the end user computer 118 can be configured with a web browsing software application for viewing web pages such as an illustrated web page 508, which can be similar to the web pages hosted on the web site 106 (FIGS. 1 and 3). For example, web pages can include content such as advertisements, videos, flash animations, and other content sourced from any of the content providers, which can include the publisher web server 102, the publisher ad server 120, the ad networks 110, and the third party servers 504. In some implementations, some or all of the content to be included in web pages can be requested using a tag. Tags can be used to reference, describe, link or point to other content. Tags can include a keyword or piece of information included in the source code of a page that can reference other content.

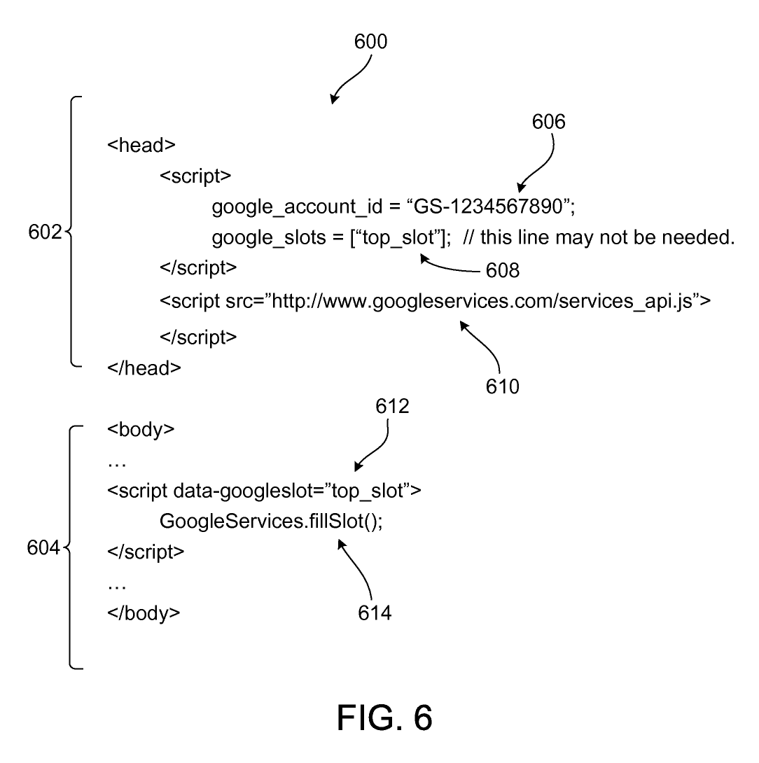

In some implementations, a tag included in the publisher's page can be used by the registrar system 502 to identify relevant configuration information for the page and forward that information for use in presenting the page. Example details and functionality of the published content are described later for FIG. 6.

In some implementations, the registrar system 502 can be configured as a physical server, a software application running on another server or combinations thereof. The registrar system 502 can be configured to manage a publisher's content placement information. The content placement information can include the mapping of services to web page marker information. In some implementations, the example web page 508 can include one or more markers displayed at any location within the web page 508. Markers (e.g., here labeled 510 and 512) can be configured to display one or more types of services. Services can refer to displaying content in a marker's location within a web page 508 or any other type of action being performed. For example, a service can include advertising, gadgets, widgets, video, text, maps and/or any other content. In some implementations, services can be managed by and sourced from one or more of the content or service providers 102, 120, 110, and 504.

Referring to web pages 508 that include advertising, the markers 510 and 512 can be configured as advertisements that can be arranged anywhere on the web page 508. For example, advertisements can be arranged near the top, sides or bottom of the page. In some implementations, advertisements can be included within other content that has been inserted into a web page.

In some implementations, markers can include one or more size specifications used by a browser, such as a web browser, to allocate space on the page 508 for the marker to be presented. For example, an advertisement service to placed in marker m1 can be presented in the marker m1 with size specifications of 200 pixels in width and 100 pixels in height. In some implementations, services may be provided to markers if the sizing constraints allow the service to be displayed. For example, if marker m1 has a limited area in which to be displayed, a service such as a large graphical advertisement may be too large for the marker m1. In this example, the service may be unavailable to the first marker 510.

The mappings of markers and their respective services can be managed and stored as assignments 514 in the registrar system 502. The assignments 514 can relate marker information to services within the registrar system 502. In some implementations, the assignments 514 for a publisher can include machine-readable data structure(s) relating a marker on a page 508 with a service represented by the marker. In some implementations, managing the assignments 514 using the registrar system 502 can allow a publisher to change the assignment of various services to their respective markers without accessing or affecting either the content of the page 518 or the one or more content or service providers. For example, the publisher yield manager 100 can access the registrar 502 to change the content or service assigned to the first marker 510. By modifying the assignment 514 for the marker 510, the service presented for the first marker 510 can be changed without accessing the assigned service stored on the one or more server providers and without accessing the content of the page 508 that includes the marker 510. For example, the marks can be associated with advertising services. This provides a convenient way for the publisher yield manager 100 to adjust the advertisements shown on the web page 508.

In some implementations, markers can be configured to represent service(s) functioning at a page level with regard to the web pages 508. Page level services can refer to managing service information using the “services_api.js” script described as an exemplary script included in the generic domain 610 for FIG. 6. For example, a service can be assigned to a group of pages, such as the pages in the “sports” area of a web site. In some implementations, assigning services to markers at the page level can include “roadblocking”. Roadblocking can refer to a publisher's content taking over most or all of the available markers on content, such as web page. For example, advertisements from a single publisher can be configured for presentation in the markers m1 and m2 where these markers are the only available markers on the page 512. In some implementations, page level services can reduce the communication burden normally required for communicating services for each marker.

For example, the first and second markers m1 and m2 can be configured for advertising services, which can be provided by one or more of the publisher ad server 120 and ad networks 110. Rendering the web page 508 that includes the markers (e.g.; 510 and 512) can involve communicating a request through the network 506 to the registrar system 502 to obtain identities of the respective services assigned to the markers m1 and m2. The response from the registrar system 502 can include information for matching markers with their respective services. The response from the registrar system 502 can further include any parameters belonging to the respective services. For example, an advertising service can include parameters for the preferred sizing of the advertisement or for the appearance of the advertisement.

FIG. 6 shows an example code segment 600 for implementing a universal tag. In this example, the segment 600 includes a “head” portion 602 and a “body” portion 604 of a web page source code. Other portions of web page source code can be included in the code segment 600. The source code of a web page can be programmed in any of various languages and can include combinations of those languages. In some implementations, the source code of a web page can be a compilation of multiple source code files programmed or written in multiple languages.

The source code of a web page can include one or more commonly used tags. The example code segment 600 shows computer programming code written in the Hypertext Markup Language (HTML) and the Javascript scripting language. Other types of markup languages and scripting languages can be included in the code segment 600. The source code for the web page 508 can be interpreted by a web browser executing on the end user computer 118. In some implementations, some or all of the code segment 600 can be interpreted or compiled into another code segment before being communicated from one of the content providers through the network 506 to the end user computer 118.

The <head> HTML tag generally starts the <head> portion at the top of the web page. This <head> tag is commonly inserted at or near the top of web page source code and comes before the <body> tag according to HTML standards (e.g.; HTML 4.0 specification from the Worldwide Web Consortium (W3C)). The <head> portion of an HTML web page can end with an html </head> tag. Other information and tags can be included within the <head> portion of a code segment. One example of information that can be included within the <head> portion of a code segment includes the title of a web page (e.g.; text enclosed by the tags <title> and </title>). In some implementations, the portion 602 can include client-side script (e.g.; the text content enclosed by the tags <script> and </script>) written in various languages such as javascript and/or vbscript that can execute calls to a server/registrar. Many types of scripting languages can be used.

The <body> HTML tag generally starts the portion of a web page that defines the page's body. The <body> portion of the segment 600 can contain the contents of the document such as text, images, colors, and graphics. The <body> portion of an HTML web page can end with an html </body> tag. Other information and tags can be included within the <body> portion of a code segment.

In some implementations, the code segment 600 can include script that communicates a request to retrieve information from one of the content providers 102, 120, 110, or 504. For example, the information can be a record of names stored in a database to be included in a page 508. In this example, the script included in the code segment 600 can trigger a process on one of the content providers to retrieve the record of names and communicate to the end user computer 508 an updated code segment 600. In some implementations, the updated code segment 600 can be interpreted by the web browser executing on the end user computer 508.

In some implementations, the head portion 602 of the code segment 600 can include an account identifier 606, a marker parameter 608 and a generic domain 610. In some implementations, the marker parameter 608 can be optional. The portion 602 can include other content including parameters, scripts, code segments and other information. In some implementations, the identifier 606, the parameter 608 and the generic domain 610 can be included in portions of the code segment 600 other than within the <head>portion. For example, the identifier 606, the parameter 608 and the generic domain 610 can be included in portions of the code segment 600 before the <head> portion, after the <head> portion, within the <body> portion or any other portion of the code segment 600.

In some implementations, the account identifier 606 can refer to an account for a publisher, such as a publisher using the publisher web server 102. The account identifier 606 can be used to search for information related to the specific publisher, or information located on the registrar system 502 and/or one of the content providers 102, 120, 110, and 504.

In some implementations, the marker parameter 608 can relate to content to be included in a page. For example, the marker parameter 608 can correspond to the location of an advertisement (e.g., “top_slot”). In some implementations, the one or more parameters 608 can be configured by another application, such as a user interface for describing names for advertisements. For example, the publisher yield manager 100 can include a user interface for generating names for advertisements, placing the names as parameters in the code segment 600, and providing a mechanism for copying the generated code segment 600 or portions thereof into a page 508. For example, the publisher yield manager 100 can adjust the number of ads to be presented on a web page 508 by describing the names for advertiser ads, house ads, or blank ads, placing the names as parameters in the code segment 600, and copying the generated code segment 600 or portions thereof into the page 508.

In some implementations, the marker parameter 608 can be accessed by the generic domain 610. For example, the generic domain 610 can access a service that processes general requests from web pages to retrieve advertising configurations. The generic domain 610 can include various scripts that can be named in various ways. For example, the illustrated generic domain 610 for FIG. 6 can be named “google_services.js”. In another example, this script included in the generic domain 610 can be named “services_api.js” or any other name. The parameter 608 can be provided to the generic domain 610 for retrieving the advertising information associated with the parameter 608.

In some implementations, the parameter 606, the parameter 608 and other parameters can be defined before or after they are accessed within the <head> portion 602 by other parameters or functions. For example, a separate code segment stored in a separate file can define and initialize the parameter 606 and the parameter 608 before it is accessed by the <head> portion 602.

The <body> portion 604 of the code segment 600 can include a script parameter 612 and a function call 614. In some implementations, the parameter 612 and other parameters can be defined before or after they are accessed within the <body> portion 604 by other parameters or functions. For example, a separate code segment stored in a separate file can define and initialize the parameter 612 before it is accessed by the <body> portion 604.

In some implementations, the function call 614 can communicate a request for information, such as from a temporary storage. For example, the function call 614 can request configuration information, such as script, from a browser cache. An example browser cache is described below.

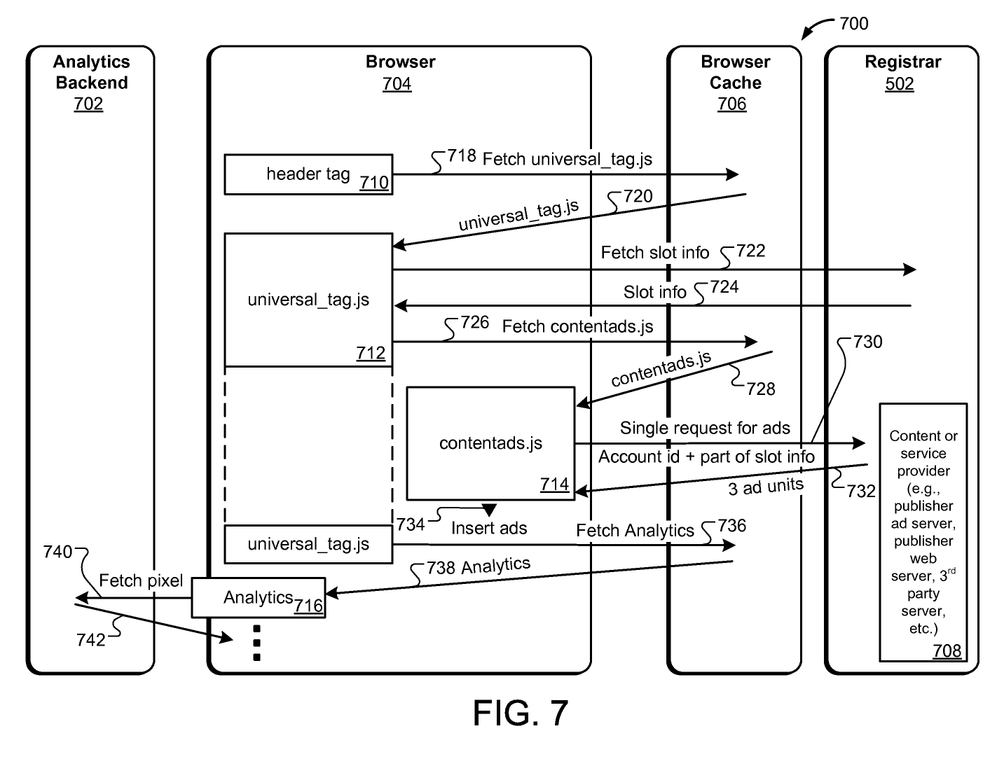

FIG. 7 shows an example sequence 700 for configuring and presenting advertising information. In some implementations, configuring advertising information can include gathering data on how the advertisements can be displayed. In one example, certain advertisements can have higher or lower priority relative to other advertisements. In another example, advertisements may have certain display size constraints and as such, may be presented in areas of display area where space is available. In some implementations, presenting advertising information can include receiving the configuration information for one or more advertisements and displaying the advertisements to a user. In some implementations, the system 700 can include an analytics backend 702, a browser 704, a browser cache 706, the registrar system 502 (FIG. 5), and one or more content or service providers 708 (which can be, e.g., the publisher ad server 120, the publisher web server 102, the ad networks 110, and/or the third party server 504). For example, the browser 704 and the browser cache 706 can be located in the end user computer 118.

In some implementations, the analytics backend 702 can include a system that gathers information about activity. For example, in the context of advertising, the analytics backend 702 can be a system that tracks statistical information including how many times an advertisement is viewed by a user of the browser 704 and/or whether the user interacts with the advertisement, to name just a few examples.

In some implementations, the browser 704 can be a software application such as a web browser that enables a user to display and interact with text, images, videos, music and other information typically located on a web page at a website on the world wide web or a local area network. Some examples of web browsers include Mozilla Firefox, Safari, Konqueror, Opera, Flock, Internet Explorer, Epiphany, K-Meleon and AOL Explorer. Browsers can be used to access the World Wide Web, and also be used to access information provided by web servers in private networks or content in file systems.

In some implementations, the browser 704 can interpret web pages such as the web page 508 described previously for FIG. 5. By way of example, the browser 704 can interpret script and tag information such as a header tag 710, a universal_tag.js script 712, a contentads.js script 714 and an analytics script 716.

Referring again briefly to the code segment 602 (FIG. 6), in some implementations the header tag 710 can refer to one or more tags included in the head portion 602 of the code segment 600. For example, the header tag 710 can include an account identifier 606 that maps or refers to a publisher identifier and can be used for fetching the configuration for the specific page.

The universal_tag.js 712 can refer to script to be interpreted by the browser 704. In some implementations, the script 712 can include information or content received from the browser cache 706 and/or the registrar 502. For example, the information received can include configuration information for placing advertisements in a page. For instance, advertisement information can include script that retrieves the assignments of available advertising spaces (e.g., markers such as the markers 510 and 512) with services to be displayed in those spaces. Referring to FIG. 6, in some implementations, the script 712 can be a script included in the generic domain 610 such as “services_api.js” or a generic domain script “google_services.js”.

The contentads.js 714 can refer to script interpreted by the browser 704 that retrieves content (such as ads, etc.) and prepares it for rendering by the browser 704. In some implementations, the script 714 can communicate a request for information from the content or service provider 708 and/or the registrar 502. For example, the communication can include a single request for advertising content. In some implementations, the communication can include an account identified for a certain publisher and advertisement marker information for the web page being interpreted by the browser 704.

The analytics 716 can refer to programming script that gathers and supplies data to the analytics backend 702. The analytics 716 is accessible to the browser 704. In some implementations, the analytics 716 can include statistical information for a page. For example, the analytics 716 can include a count of how many times certain content is viewed in a page displayed by the browser 704. In another example, the analytics 716 can include a count of how many times a certain advertisement is “clicked” on from a page displayed by the browser 704.

The browser cache 706 can store copies of information passing through it. In some implementations, the browser cache 706 can reduce bandwidth usage, load on the servers and perceived wait time for a user. In some implementations, the browser cache 706 can be accessed as subsequent requests for stored information are received. For example, the universal_tag.js script 712, the contentads.js script 714 and/or the analytics script 716 can be cached and used more than once by the browser 704.

For example, the browser 704 fetches script from the browser cache 706. This fetch request can be referred to as “fetch universal_tag.js” and is here illustrated as step 718. In response, the browser cache 706 can send the script (e.g., the javascript “universal_tag.js”) to the browser 704, illustrated as step 720.

In some implementations, the browser 704 can fetch information from the registrar 502. In other implementations, the browser 704 can fetch information from the content or service provider 708. This fetch request can be referred to as “fetch slot info” and is here illustrated as step 722. In response, the registrar 502 can send the information (e.g., the slot information) to the browser 704, illustrated as step 724. The browser 704 can execute the universal_tag.js 712 script. The script 712 can use the information retrieved from the registrar system 502.

The browser 704 can fetch script from the browser cache 706. This fetch request can be referred to as “fetch contentads.js” and is here illustrated as step 726. In response, the browser cache 706 can send the script (e.g., the javascript “contentads.js”) to the browser 704, illustrated as step 728.

The browser 704 can send a communication to the content or service provider 708 for one or more services to be performed. For example, this request can include a request for advertisement information. In some implementations, the request can include a single request for multiple advertisements to be placed in a plurality of slots, illustrated as step 730. The request communicated at step 730 can include parameters. For example this single request can include identification information (e.g., the account identifier 606, FIG. 6) that relates a publisher and the publisher's respective content configuration information for the advertisements available for the publisher. In response, the registrar 502 can send multiple advertisements to the browser 704, illustrated as step 732. In some implementations, the content (e.g., advertisements) received from the content or service provider 708 can be included in the page interpreted by the browser 704, illustrated as step 734.

The browser can send a communication 736 to the browser cache 706 for information. In some implementations, the communication 736 can be sent to a content or service provider instead of the browser cache 706. For example, the first time the communication 736 is sent, information may not be available in the cache 706. In this example, another server or backend system can provide the response to a service, such as the analytics service 716. In some implementations, the request can include a request for statistical code. For example, statistical code can refer to the programming code that forms the analytics 716. In response, the browser cache 706 can send the statistical (e.g., analytics) code to the browser 704, illustrated as step 738.

The analytics 716 can determine statistical information and communicate it to the analytics backend 702. In some implementations, this communication can be referred to as “fetch pixel” and is illustrated as step 740. In other implementations, the communication can include one or more requests. In response, the analytics backend 702 can send a communication to a user interface for viewing analytics information, illustrated as step 742. In some implementations, the communication sent at step 742 can include statistical information such as accumulated page views for a web page, where the number of page views is maintained by the analytics backend 702. For example, the user interface for viewing analytics information can be viewable in a browser. In this example, the user interface can be a web page accessible to a publisher for viewing aggregated statistical information. In other implementations, the communication sent at step 742 can include other information such as the geographic location of the request, duration of time spent viewing the page 508, or the number of unique visitors to the page 508.

In some implementations, the services available for a marker (e.g., markers 510 and 512) can be managed by one or more registrar systems 502, where the registrar system 502 can provide information needed to retrieve parameters for services using marker information. For example, a query to a registrar system 502 can include marker information. The identifiers for the markers can be used to look up parameters for the services assigned to the markers.

In response to the query, the registrar system 502 can return the assignment of a marker to a service. In some implementations, this response can reduce the size of the response and thus reduce the bandwidth and network traffic involved. In some implementations, parameters can be included as part of the query. For example, an advertising map service may include default length and width size parameters. Using this advertising example, the query can include length and width parameters to override the default parameters.

By way of further example, some services may not have their respective parameters managed by the registrar system 502. In this example, a second query may be sent to return the parameters. In some implementations, the second query can include marker information for markers with parameters not managed by the registrar system 502.

In some implementations, queries made to the registrar system 502 can be formulated to limit the amount of responses that are sent to a browser 704. In some implementations, a service can be presented multiple times with a similar mapping of markers to services. As a result, the registrar 502 may store a default or common service for a publisher. For example, advertising may be a service commonly requested by a publisher for inclusion in a page. In this example, advertising can be stored by the publisher ad server 120 as the default service for a publisher. In some examples, an advertising service, such as ad networks 110, can be configured as a default service without being the most commonly used service for a publisher. In such examples, if a marker does not include an assignment to a service, the configured default service can be used. In some examples, the default can be mentioned explicitly in the service information for fewer than all slots covered by the service information.

In some implementations, queries made to the registrar system 502 can be formulated to request the configuration for most or all of the markers in a page. For example, the page 508 can be a web page with markers 510 and 512 that are assigned advertising services. In this example, the query can avoid sending a response to the browser 704 as both markers 510 and 512 are presenting the default service, in this case advertising.

In some implementations, versions of assignments (e.g., the assignments 514, FIG. 5) can be temporarily stored and accessed. In some implementations, the version can be stored in a file. One example of a file commonly used for storing temporary information is a “cookie.” A cookie refers to text sent by a server (e.g., the publisher web server 102) to a device (e.g., the end user computer 118). Cookies can be used for authenticating, tracking and maintaining information. For example, the contents of a user's shopping cart while shopping for items on the internet can be stored in a cookie. In some implementations, one or more content or service providers can manage configuration information related to the assignments 514. If the configuration information is updated, the one or more content or service providers can maintain a version, such as a numeric value, to be compared with the version stored in the cookie. For example, the numeric value can be incremented if the configuration information changes for a particular assignment 514. For instance, a change to one or more of the services assigned to a marker can trigger an update to the version number.

At the first visit to a page, the web browser 704 can communicate a request to the content or service provider 708 to retrieve the latest version of the configuration information for an assignment 514. In response, the content or service provider 708 can send a script to create a cookie that includes the latest version of the assignment 514. For example, the latest version of an assignment mapping after the first visit to a page can be stored in a cookie as zero.

Following the above example, at the second visit to a page, the cookie includes a numeric value of zero. The browser 704 can communicate a request to the content or service provider 708 that includes the version of the assignment 514 for the page being viewed. In some implementations, the version of the assignment that is maintained on the content or service provider 708 can be unchanged since the last visit to the page. In some implementations, a response to update the version stored in the cookie is unnecessary if the version of the assignments match.

Following the above example further, at the third visit to a page, the content or service provider 708 receives an update to the configuration for an assignment. The update has incremented the version for the assignment from zero to one. For example, the marker (e.g., the second marker 512) can be reconfigured from a previous service such as an advertising service to a video service. In this example, another one or more markers (e.g. the first marker 510) may be assigned a default service that is unchanged since the last visit to the page. In some implementations, a request to get the latest assignment versions can be sent at the end of a page as the page is interpreted by the browser 704. This request can update the cookie stored on the end user computer 118.

Following the above example further, at the fourth visit to a page, the assignment 514 has a version of one stored on the content or service provider 708 and a version of one in the cookie stored on the end user computer 118. The browser 704 can communicate a request to the content or service provider 708 that includes the version number of one. In some implementations, the response can be retrieved from the cache (e.g., the browser cache 706). In some implementations, a response to update the version stored in the cookie is unnecessary if the version of the assignments match and updates have not been received by the content or service provider 708.

In some implementations, the capability to store temporary information can be disabled. For example, web browsers such as those described earlier can include settings for enabling or disabling the storage of temporary information such as cookie files. In this example, the version information can be managed by the content or service provider 708 and can be refreshed at regular time intervals, such as once per day.

In some implementations, a publisher can temporarily change the “normal” configuration for a marker/service pairing (e.g., the assignment 514). In some implementations, a user interface can be provided for overriding the normal configuration for assignments 514. In some implementations, the overriding can be accomplished by storing a temporary account identifier (e.g., the identifier 606) in a temporary cookie. The temporary account can be used to access the changed configurations, in some implementations, for experimental purposes. For example, a publisher can change the arrangement of services and markers on a page to achieve a better response to their content. The publisher yield manager 100 can be used to experiment with advertising placement on a page 508.

In some implementations, services for a page can be assigned to a set of pages (page level) instead of for individual markers on the page. In some implementations, the page level services can be maintained as a configuration file stored on the content or service provider 708. For example, the analytics service 716 can be assigned to a group of pages, such as the pages in the “sports” area of a web site. In this example, an expiration time can be maintained. In some implementations, the last update time for a service associated with a marker can be stored along with the version information in a temporary storage cookie. If the version information changes, the last update time is stored in the cookie. If an unacceptable amount of time passes since the last update, a request can be sent to the content or service provider 708 to retrieve the latest version for a service. This request can be made at the end of page to avoid affecting the view of the page.

In some implementations, the capability to temporarily store version information, for example using a cookie, can be disabled. If temporary version information storage is disabled, the <head> portion 602 of the code segment 600 can communicate a request to the content or service provider 708 each time the page 508 is presented. In some implementations, accessing the browser cache 706 to retrieve version information can be avoided. For example, the content or service provider 708 can respond to the page 508 with different service assignments 514 each time the page 508 is presented allowing a publisher to perform experiments regarding services assignments 514.

In some implementations, configuring placement separately for each of the markers (e.g., the markers 510 and 512) on a page (e.g., the page 508) can be avoided by storing the placement of the markers based on the URL of the page where the markers are presented with their respective services. Client-side storage refers, for example, to temporary storage available that is stored in ways other than a cookie file. For example, the HTML 5.0 specification includes client-side “sessionStorage” attributes. The sessionStorage is accessible to any page from the same web site opened in the page for that particular browser window. In some implementations, a combination of client-side storage and the registrar 502 can be used to manage the marker information based on the URL of the page presenting the markers.

The use of the registrar 502 and client-side storage to manage markers, universal tags, and service information can reduce the communications back and forth between a client and a server, such as the content or service provider 708.

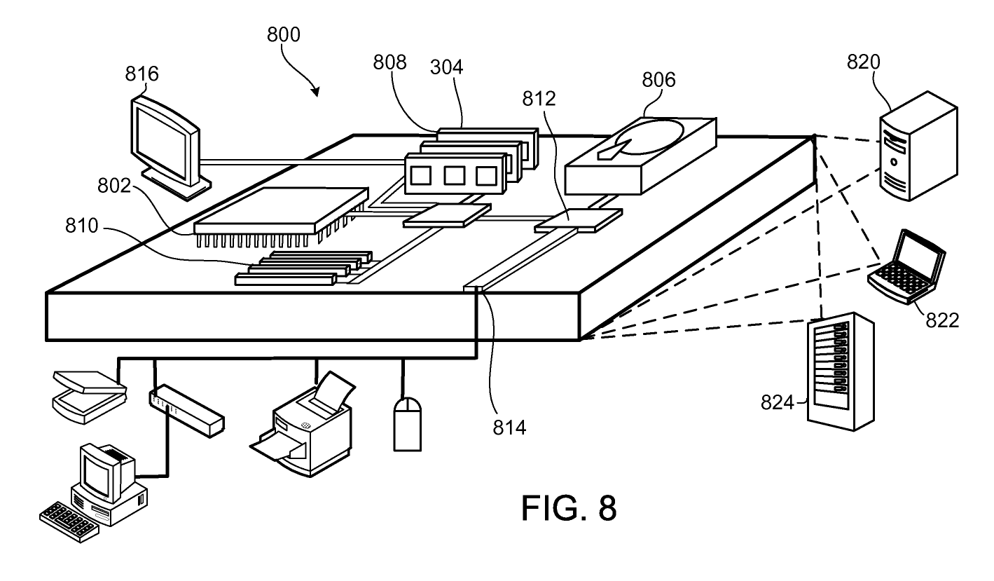

FIG. 8 is a schematic representation of a general computing system 800 that can be used to implement one or more of the machine learning module 116, the publisher yield manager 100, the end user computer 118, the publisher server computer 102, the ad network 110, or their components. Computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described or claimed in this document.

Referring to FIG. 8, the computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 1000. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on processor 802, or a propagated signal.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Each of such devices (e.g., standard server, rack server system, personal computer, laptop computer) may contain one or more of computing device 800, and an entire system may be made up of multiple computing devices 800 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, trackball, touch-sensitive screen, or iDrive-like component) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations and examples have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated. For example, while this specification contains many specific implementation details, these should not be construed as limitations on the scope of any invention or of what may be claimed, but rather as descriptions of features that may be specific to particular implementations of particular inventions. Certain features that are described in this specification in the context of separate examples can also be implemented in combination in a single example. Conversely, various features that are described in the context of a single example can also be implemented in multiple examples separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

In addition, the logic flows depicted in the figures do not require the particular order shown, or sequential order, to achieve desirable results. Other steps may be provided, or steps may be eliminated, from the described flows, and other components may be added to, or removed from, the described systems.

The revenue model can include parameters that are different from those described above. Optimizing the publisher yield does not necessarily have to be maximizing the yield. For example, the publisher may wish to meet certain ad revenue goals that increase by a certain percentage each month. Accordingly, other implementations are within the scope of the following claims. For example, the end user computer 118 can any computing device, such as a desktop computer, a notebook computer, a mobile phone, or an internet terminal. In the examples described above, the publisher yield manager 110 determines the optimum number of advertiser ads 112 and house ads 114 for each page of the web sites 106. The publisher yield manager 110 can also optimize parameters for each “section” of the web sites 106, in which a “section” may refer to, e.g., a web site, a web page, a portion of a web page, or a document embedded in a web page. For example, a web page may include two sections (the user sees the first section when the web page is first opened in a browser, and the user scrolls down to see the second section), and the publisher yield manager 110 may determine that the optimum numbers of ads for the first and second sections are two and three, respectively.

In some implementations, the publisher yield manager, instead of adjusting the parameter values (e.g., the min-CPM or the number of advertiser ads or house ads on a web page), the publisher yield manager may make recommendations for adjustments of the parameter values, and let the operator of the publisher web server 102 determine whether to make the adjustments.

What is claimed is:

1. A computer implemented method for managing publisher yield, the method comprising:
establishing a revenue model representing a relationship between ad revenue for a publisher of a web site and a plurality of parameters, the parameters comprising at least one of (a) a minimum price for an advertiser to place an ad on a web page of the web site through an ad network, (b) a number of advertiser ads presented on the web page, or (c) a number of house ads presented on the web page, the advertiser ads being provided by advertisers and the house ads promoting products, services, or web page content of the publisher;
at one or more computers, adjusting values of the parameters based on the revenue model to increase the ad revenue to the publisher, including adjusting at least one of the minimum price for an advertiser to place an ad on the web page through the ad network, the number of advertiser ads presented on the web page, or the number of house ads presented on the web page; and
outputting at least one of (d) an instruction to an ad network to cause the ad network to adjust the minimum price for an advertiser to place an ad on the web page through the ad network, (e) an instruction to cause a web server to adjust the number of advertiser ads on the web page, or (f) an instruction to cause the web server to adjust the number of house ads on the web page.

2. The method of claim 1 in which the revenue model applies weights to the parameters, and the method comprises adjusting the weights applied to the parameters to increase accuracy of the revenue model in representing the relationship between the ad revenue for the publisher and the plurality of parameters.

3. The method of claim 1, comprising determining values for the parameters that maximize the ad revenue to the publisher.

4. The method of claim 1 in which the minimum price for an advertiser to place an ad on the web page through an ad network comprises the minimum price for an advertiser to place an ad at a particular ad space of the web page through the ad network.

5. The method of claim 1 in which the minimum price comprises a minimum cost per thousand impressions (min-CPM).

6. The method of claim 1 in which the web site includes a plurality of web pages, and the parameters comprise the number of advertiser ads presented at each of the web pages.

7. The method of claim 1 in which the web site includes a plurality of web pages, and the parameters comprise the number of house ads presented at each of the web pages.

8. The method of claim 1 in which adjusting the values of the parameters at one or more computers comprises at a web server hosting the web page, adjusting at least one of a number of advertiser ads or a number of house ads presented on the web page.

9. The method of claim 1 in which adjusting the values of the parameters at one or more computers comprises at a computer of the ad network, adjusting the minimum price.

10. The method of claim 1 in which adjusting the values of the parameters at one or more computers comprises at a computer, sending instructions to a web server hosting the web page to cause the web server to adjust at least one of a number of advertiser ads or a number of house ads presented on the web page.

11. The method of claim 1 in which adjusting the values of the parameters at one or more computers comprises at a computer, sending instructions to the ad network to cause the ad network to adjust the minimum price.

12. A computer implemented method for managing publisher yield, the method comprising:
setting various minimum prices for placement of ads on a web page of a web site of a publisher through an ad network for various portions of web traffic;
identifying ad revenue to the publisher generated by the ads provided by the ad network for each minimum price during a respective portion of web traffic;
determining, at a computer, a particular minimum price that results in maximum ad revenue for the publisher;
setting the minimum price for the placement of ads on the web page through the ad network at the particular minimum price; and
providing the web page including ads or links to the ads selected according to the particular minimum price to end users.

13. The method of claim 12 in which the ad revenue comprises ad revenue per predefined number of clicks.

14. The method of claim 12 in which the computer iteratively adjusts the minimum price for placement of ads on the web site through the ad network and determines the ad revenue to the publisher generated by the ads after adjustment of the minimum price, the iterative adjustment for increasing the ad revenue over time.

15. The method of claim 12 in which the various portions of web traffic comprises page views associated with the web page during different periods of time.

16. The method of claim 12 in which the various portions of web traffic comprises different portions of all of the page views associated with the web page during a same period of time.

17. A computer implemented method for managing publisher yield, the method comprising:
presenting ads on a web page of a web site of a publisher;
identifying ad revenue to the publisher generated by the ads;
determining, at a computer, the number of ads presented at the web page that results in maximum ad revenue to the publisher; and
presenting the number of ads at the web page.

18. The method of claim 17 in which the ad revenue comprises ad revenue per predefined number of clicks.

19. The method of claim 17 in which the computer iteratively adjusts the number of ads presented at the web page and determines the ad revenue to the publisher generated by the ads, the iterative adjustment for increasing the ad revenue over time.

20. The method of claim 17 in which the web site includes a plurality of web pages, and the method comprises adjusting the number of ads presented at each of the web pages.

21. The method of claim 17 in which determining the number of ads presented at the web page that results in maximum ad revenue to the publisher comprises determining at least one of the number of advertiser ads or the number of house ads presented at the web page.

22. The method of claim 17, comprising determining that placing a house ad at an ad space on the web page increases the ad revenue more than placing an advertiser ad at the ad space, and placing the house ad at the ad space.

23. The method of claim 17, comprising providing a universal tag in a web page having multiple ad units to enable a web browser rendering the web page to send one request to an ad server for requesting multiple ads for the multiple ad units.

24. The method of claim 23, comprising instructing the ad server to respond to the request with a number of advertiser ads that is less than requested by the web browser.

25. A system comprising:
a machine learning module to provide a revenue model representing a relationship between ad revenue for a publisher of a web site and a plurality of parameters, the parameters comprising at least one of (a) a minimum price for an advertiser to place an ad on a web page of the web site through an ad network, (b) a number of advertiser ads presented on the web page, or (c) a number of house ads presented on the web page, the advertiser ads being provided by advertisers and the house ads promoting products, services, or web page content of the publisher; and
a yield manager to use the revenue model to adjust values of the parameters to increase the ad revenue to the publisher, including adjusting at least one of the minimum price for an advertiser to place an ad on the web page through the ad network, the number of advertiser ads presented on the web page, or the number of house ads presented on the web page.

26. The system of claim 25 in which the revenue model comprises weights that are applied to the parameters, and the machine learning module adjusts the weights applied to the parameters to increase accuracy of the revenue model in representing the relationship between the ad revenue for the publisher and the plurality of parameters.

27. The system of claim 25 in which the yield manager adjusts the values of the parameters to maximize the ad revenue to the publisher.

28. The system of claim 25 in which the minimum price comprises a minimum cost to an advertiser per predefined number of impressions.

29. The system of claim 25 in which the minimum price comprises a minimum cost per thousand impressions (min-CPM).

30. The system of claim 25 in which the web site includes a plurality of web pages, and the parameters comprise the number of advertiser ads presented at each of the web pages.

31. The system of claim 25 in which the web site includes a plurality of web pages, and the parameters comprise the number of house ads presented at each of the web pages.
